(19) United States
(12) Patent Application Publication
(10) Pub. No.: US 2025/0187341 A1
(43) Pub. Date: Jun. 12, 2025

(54) INKJET RECORDING APPARATUS

(71) Applicant: KYOCERA Document Solutions Inc., Osaka (JP)

(72) Inventors: Takashi MORITA, Osaka-shi (JP); Tomohiro SUE, Osaka-shi (JP); Tatsuhiko YOSHII, Osaka-shi (JP)

(73) Assignee: KYOCERA Document Solutions Inc., Osaka (JP)

(21) Appl. No.: 18/969,196

(22) Filed: Dec. 4, 2024

(30) Foreign Application Priority Data
Dec. 6, 2023 (JP) 2023-206163

(51) Int. Cl. B41J 2/165

(52) U.S. Cl. CPC B41J 2/16552; B41J 2002/16558; B41J 2002/16564; B41P 2235/21

(57) ABSTRACT

An inkjet recording apparatus includes an inkjet head, a dipping vessel, a lifting device and a removing device. The dipping vessel stores a cleaning liquid. The lifting device dips a nozzle surface of the inkjet head in the cleaning liquid by lifting or lowering the dipping vessel or the inkjet head. The removing device is provided in the dipping vessel and removes adhered material from the nozzle surface.

### INCORPORATION BY REFERENCE

This application is based on and claims the benefit of priority from Japanese patent application No. 2023-206163 filed on Dec. 6, 2023, which is incorporated by reference in its entirety.

### BACKGROUND

The present disclosure relates to an inkjet recording apparatus.

In an inkjet recording apparatus, moisture evaporates from ink in a nozzle of an inkjet head during a period when an image forming job is not executed, and the nozzle may be clogged by an increase in viscosity of the ink. To prevent the clogging, the ink in the nozzle is purged to the cap. However, if the ink remaining on the nozzle surface is left, there is a problem that the ink falls on the sheet during the execution of the image forming job or the ink sticks to the nozzle surface. Therefore, a technique for removing the ink remaining on the nozzle surface has been studied. For example, a configuration has been proposed in which the ink is removed from the nozzle surface by sliding a blade in contact with the nozzle surface.

In the above configuration, since a cleaning liquid is swelled from a hole of a supply member adjacent to the nozzle surface and the blade slides along the nozzle surface after scraping the cleaning liquid, there is a problem that an amount of the cleaning liquid supplied to the nozzle surface is small, and an ability for removing adhered material from the nozzle surface is low.

### SUMMARY

An inkjet recording apparatus according to the present disclosure includes an inkjet head, a dipping vessel, a lifting device and a removing device. The dipping vessel stores a cleaning liquid. The lifting device dips a nozzle surface of the inkjet head in the cleaning liquid by lifting or lowering the dipping vessel or the inkjet head. The removing device is provided in the dipping vessel and removes adhered material from the nozzle surface.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view schematically showing an internal configuration of an inkjet recording apparatus according to one embodiment of the present disclosure.

FIG. 2 is a perspective view showing an arrangement of inkjet heads according to the embodiment of the present disclosure.

FIG. 3 is a cross-sectional view showing the inkjet head according to the embodiment of the present disclosure.

FIG. 4 is a diagram schematically showing a configuration of an ink supply part according to the embodiment of the present disclosure.

FIG. 5 is a block diagram showing an electrical configuration of a maintenance device according to the embodiment of the present disclosure.

FIG. 6 is a perspective view showing an image forming unit according to the embodiment of the present disclosure.

FIG. 7 is a disassembled view showing the image forming unit according to the embodiment of the present disclosure.

FIG. 8 is a perspective view showing the maintenance device according to the embodiment of the present disclosure.

FIG. 9 is a perspective view showing the maintenance device according to the embodiment of the present disclosure.

FIG. 10 is a perspective view showing a removing device according to the embodiment of the present disclosure.

FIG. 11 is a perspective view showing a blade unit according to the embodiment of the present disclosure.

FIG. 12 is a perspective view showing a cross section of the removing device according to the embodiment of the present disclosure.

FIG. 13 is a perspective view showing a cross section of the removing device according to the embodiment of the present disclosure.

FIG. 14 is a cross-sectional view showing the removing device according to the embodiment of the present disclosure.

FIG. 15 is a cross-sectional view showing the removing device according to the embodiment of the present disclosure.

FIG. 16 is a cross-sectional view showing the removing device according to the embodiment of the present disclosure.

### DETAILED DESCRIPTION

Hereinafter, with reference to the drawings, an inkjet recording apparatus 1 according to the present embodiment of the present disclosure will be described.

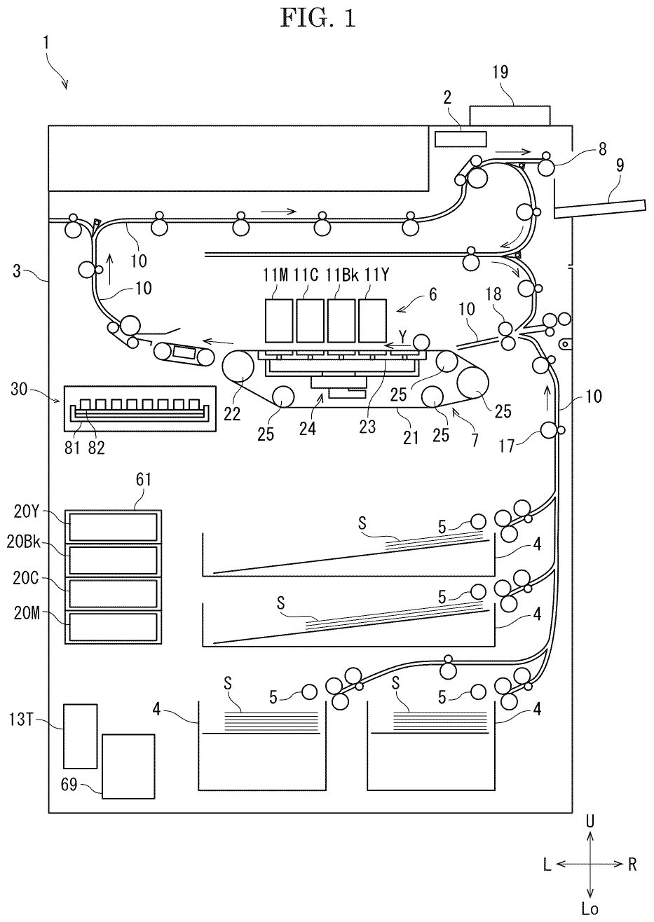

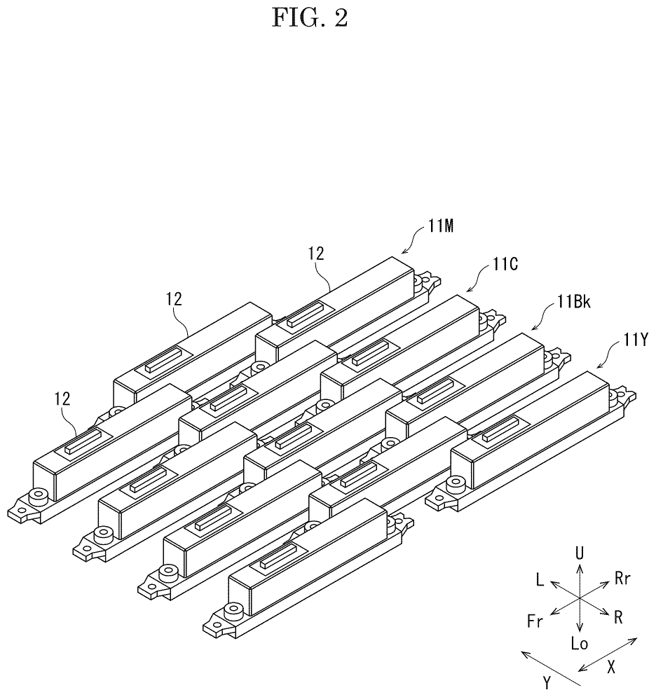

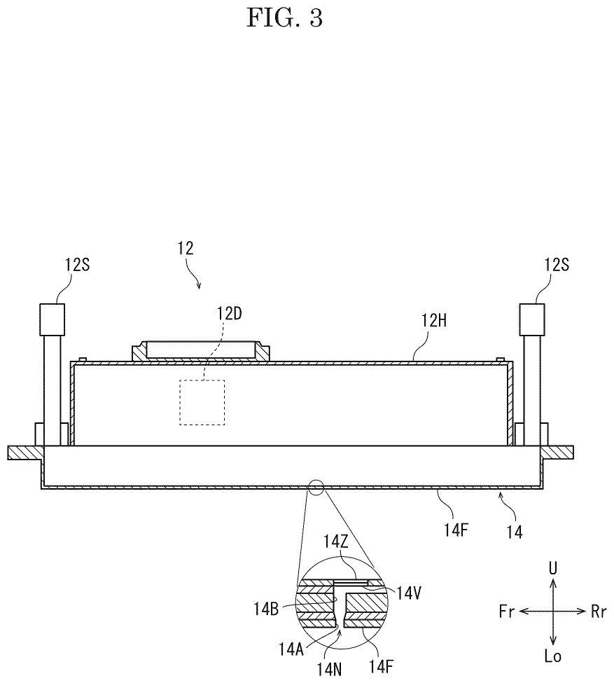

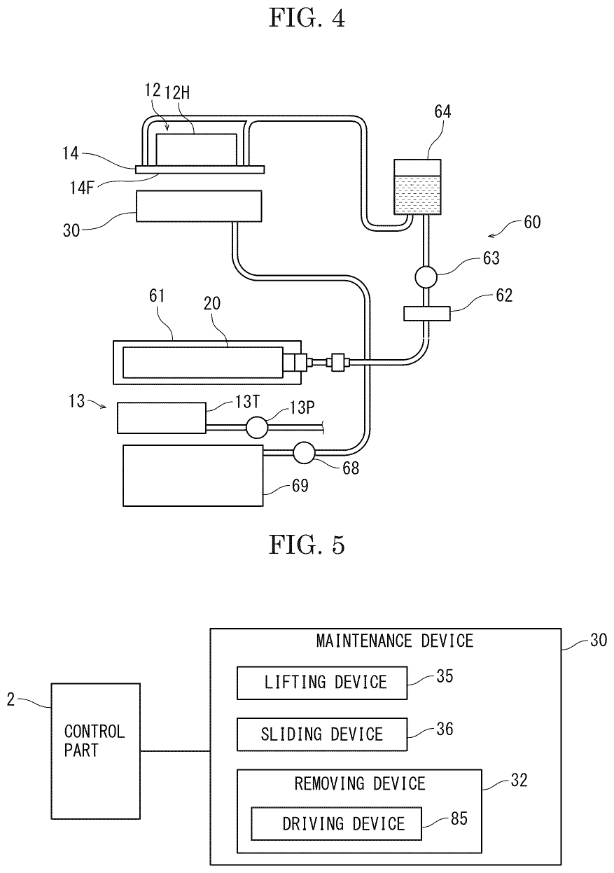

First, an entire configuration of the inkjet recording apparatus 1 will be described. FIG. 1 is a front view schematically showing the inkjet recording apparatus 1. FIG. 2 is a perspective view showing an arrangement of inkjet heads 12. FIG. 3 is a cross-sectional view showing the inkjet head 12. FIG. 4 is a view schematically showing an ink supply part 60. Hereinafter, the front side of the paper surface on which FIG. 1 is drawn is defined as the front side of the inkjet recording apparatus 1, and the left-and-right direction will be described with reference to the direction in which the inkjet recording apparatus 1 is viewed from the front side. In each drawing, U, Lo, L, R, Fr and Rr indicate the upper, lower, left, right, front and rear, respectively.

The inkjet recording apparatus 1 (see FIG. 1) includes a box-shaped body housing 3. In the lower portion in the body housing 3, a sheet feeding cassette 4 in which sheets S such as a plain paper and a coated paper are stored, and a sheet feeding roller 5 which feeds the sheets S rightward from the sheet feeding cassette 4 are provided. Above the sheet feeding cassette 4, a conveying unit 7 which attracts and conveys the sheet S in the Y direction is provided. Above the conveying unit 7, an image forming unit 6 which forms an image by ejecting ink is provided. In the right upper portion in the body housing 3, a discharge roller 8 which discharges the sheet S on which the image is formed and a discharge tray 9 on which the discharged sheet S are stacked are provided.

Inside the body housing 3, a conveyance path 10 is provided from the sheet feeding roller 5 to the discharge roller 8 through a gap between the conveying unit 7 and the image forming unit 6. The conveyance path 10 is mainly formed of plate-like members facing each other with a gap for passing the sheet S, and a conveying roller 17 for conveying the sheet S while holding the sheet S is provided at a plurality of positions in the conveyance direction Y. A registration roller 18 is provided on the upstream side of the image forming unit 6 in the conveyance direction Y.

The conveying unit 7 includes an endless conveying belt 21, a support plate 23 and a suction part 24. The conveying belt 21 has a large number of air holes (not shown), and is wound around a driving roller 25 and a driven roller 22. The support plate 23 has a large number of air holes (not shown), and its upper surface is in contact with the inner surface of the conveying belt 21. The suction part 24 sucks air through the air holes of the conveying belt 21 and the air holes of the support plate 23, so that the sheet S is attracted to the conveying belt 21. When the driving roller 25 is driven in the counterclockwise direction by a driving part (not shown) including a motor and a reduction gear, the conveying belt 21 travels in the counterclockwise direction, and the sheet S attracted to the conveying belt 21 is conveyed.

The image forming unit 6 includes head units 11Y, 11Bk, 11C and 11M (collectively referred to as the head unit 11). The head unit 11 includes one or more inkjet heads 12, for example, three inkjet heads 12 arranged in a staggered pattern (see FIG. 2). Ink containers 20Y, 20Bk, 20C and 20M (collectively referred to as the ink container 20) filled with the black, cyan, magenta, and yellow ink are connected to the respective head units 11.

The inkjet head 12 (see FIG. 3) includes a rectangular parallelepiped housing 12H whose longitudinal direction is along the front-and-rear direction, a nozzle plate 14 provided at the bottom of the housing 12H, and a socket 12S to which a pipe for supplying the ink is connected. The nozzle plate 14 is provided with a large number of nozzles 14N arranged in the front-and-rear direction. The nozzle 14N includes a branch channel 14B branched from the downstream side of the socket 12S, and an ejection port 14A provided on a nozzle surface 14F which is the lower surface of the nozzle plate 14. A diaphragm 14V also serves as a part of the inner wall of the branch channel 14B. The diaphragm 14V is provided with a pressurizing element 14Z. As the pressurizing element 14Z, a piezoelectric element, an electrostatic actuator, a heater or the like are used. A driving circuit 12D for driving the pressurizing element 14Z is connected to the pressurizing element 14Z.

The inkjet recording apparatus 1 includes an ink supply part 60 (see FIG. 4). In the figure, one ink supply part 60 corresponding to one color ink is shown, but since the four colors of the ink are used in this embodiment, the same four ink supply parts 60 are provided. The inkjet recording apparatus 1 includes a container attachment part 61 to which the ink container 20 is attached, a filter 62 which filters the ink, a pump 63 which sucks the ink from the ink container 20 through the filter 62, and a sub-tank 64 which stores the ink fed from the pump 63.

A liquid level in the sub-tank 64 is adjusted to be slightly lower than the nozzle surface 14F. Negative pressure acts on the ink in the nozzle 14N by a head difference between the liquid surface and the nozzle surface 14F, and a meniscus is formed in the nozzle 14N. After the ink is ejected from the inkjet head 12, a surface tension of the ink acts to reduce the surface area of the meniscus, and the ink of the reduced amount is drawn into the inkjet head 12 from the sub-tank 64 by a negative pressure generated thereby.

A control part 2 (see FIG. 1) includes an arithmetic part and a storage part (not shown). The arithmetic part is, for example, a CPU (Central Processing Unit). The storage part includes a storage medium such as ROM (Read Only Memory), RAM (Random Access Memory), EEPROM (Electrically Erasable Programmable Read Only Memory), and the like. The arithmetic part reads the control program stored in the storage part and executes various processes. The control part 2 may be implemented by an integrated circuit that does not use software.

A display operation part 19 is provided on the upper portion of the body housing 3 (see FIG. 1, FIG. 2). The display operation part 19 includes a display panel, a touch panel laminated on the display panel, and a keypad (not shown). The control part 2 displays a screen representing an operation menu, a status, or the like of the inkjet recording apparatus 1 on the display panel, and controls each part of the inkjet recording apparatus 1 in accordance with the operation detected by the touch panel and the keypad.

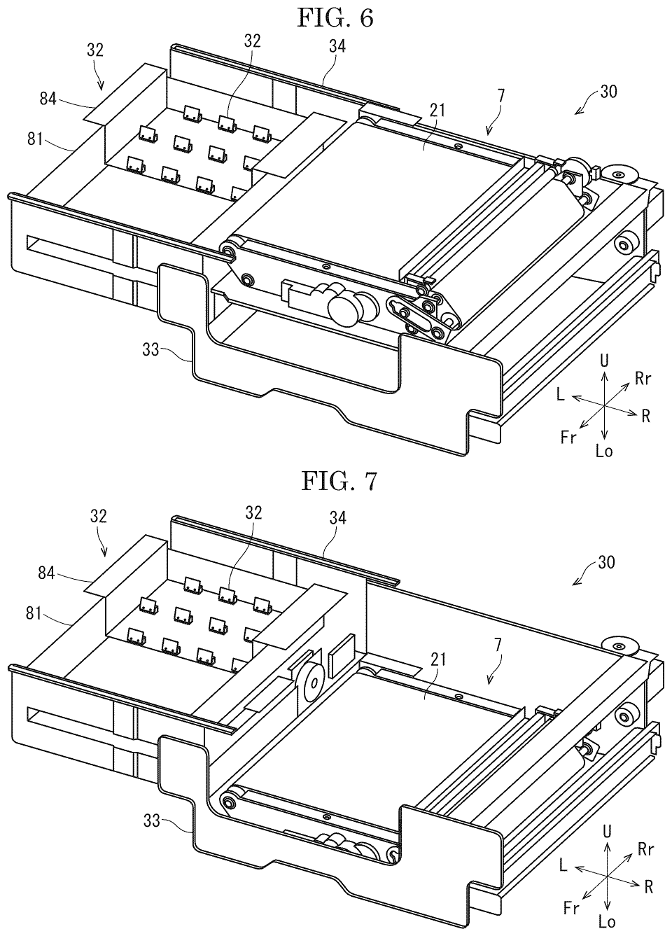

The basic image forming operation of the inkjet recording apparatus 1 is as follows. When an image forming job is inputted to the inkjet recording apparatus 1 from the display operation part 19 or an external computer, the sheet feeding roller 5 feeds the sheet S from the sheet feeding cassette 4 to the conveyance path 10, and the registration roller 18 whose rotation is stopped corrects the skew of the sheet S. When the registration roller 18 sends the sheet S to the conveying unit 7 at a predetermined timing, the conveying unit 7 attracts the sheet S to the conveying belt 21, and conveys the sheet S in the Y direction. The driving circuit 12D supplies an ejection signal corresponding to the image data to the pressurizing element 14Z in synchronization with the conveyance of the sheet S. Thus, the ink is ejected from the nozzle 14N to form an image on the sheet S. The discharge roller 8 discharges the sheet S on which the image is formed to the discharge tray 9.

[Maintenance Device] FIG. 5 is a block diagram showing an electrical configuration of the maintenance device 30. FIG. 6 to FIG. 9 are perspective views showing the maintenance device 30. The maintenance device 30 includes a frame 33, a carriage 34, a removing device 32, a lifting device 35, and a sliding device 36.

[Frame, Carriage] The frame 33 (see FIG. 8) is fixed to the body housing 3, and supports the carriage 34 and the conveying unit 7. The carriage 34 supports the removing device 32. The removing device 32 includes a blade 82.

[Lifting Device] The conveying unit 7 is supported by the frame 33 via the lifting device 35 (see FIG. 5). The lifting device 35 includes, for example, a ball screw, a belt driving device, and the like. The lifting device 35 lifts and lowers the conveying unit 7 to an image forming position (see FIG. 6) when the image forming operation is performed and to a lower retracted position (see FIG. 7) below the image forming position. When the conveying unit 7 is moved to the image forming position, the conveying unit 7 is positioned so that a distance between the conveying belt 21 and the nozzle surface 14F becomes a distance suitable for the image formation. When the conveying unit 7 is moved to the lower retracted position, a space in which the removing device 32 can be moved is formed between the upper surface of the conveying belt 21 and the nozzle surface 14F.

[Sliding Device] The carriage 34 is supported by the frame 33 via the sliding device 36 (see FIG. 5). The sliding device 36 includes, for example, a ball screw, a belt drive device, a rack and pinion, and the like. The removing device 32 is supported by the carriage 34, and slides in the left-and-right direction together with the carriage 34 by the sliding device 36. When the conveying unit 7 is positioned at the lower retracted position, the sliding device 36 slides the removing device 32 to a lateral retracted position (see FIG. 7) not facing the image forming unit 6 and a facing position (see FIG. 8) facing the image forming unit 6.

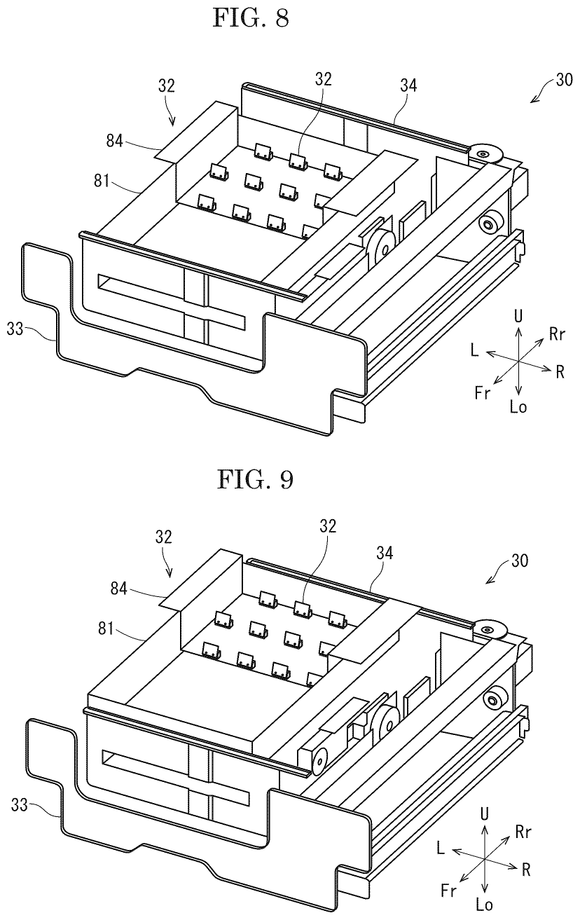

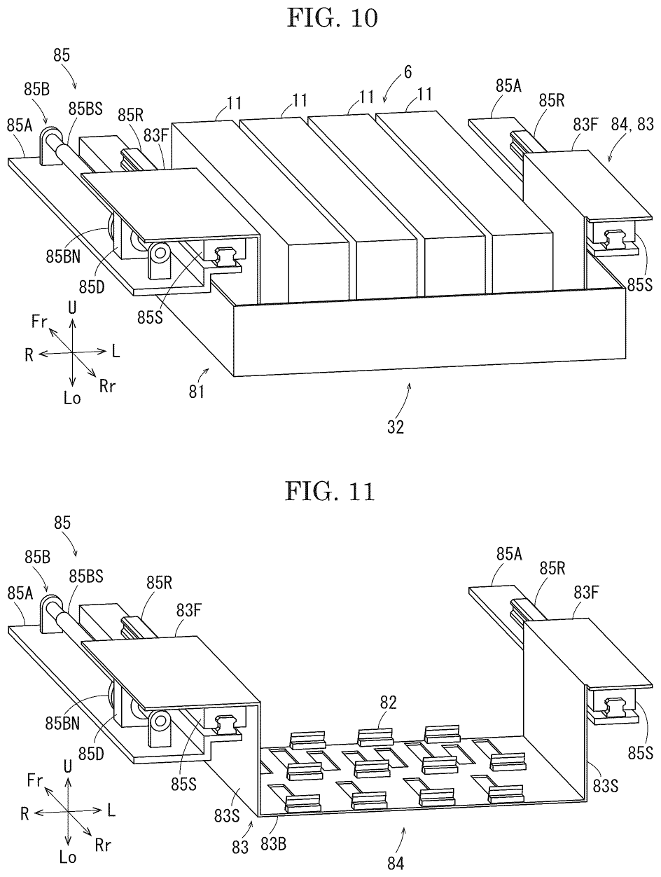

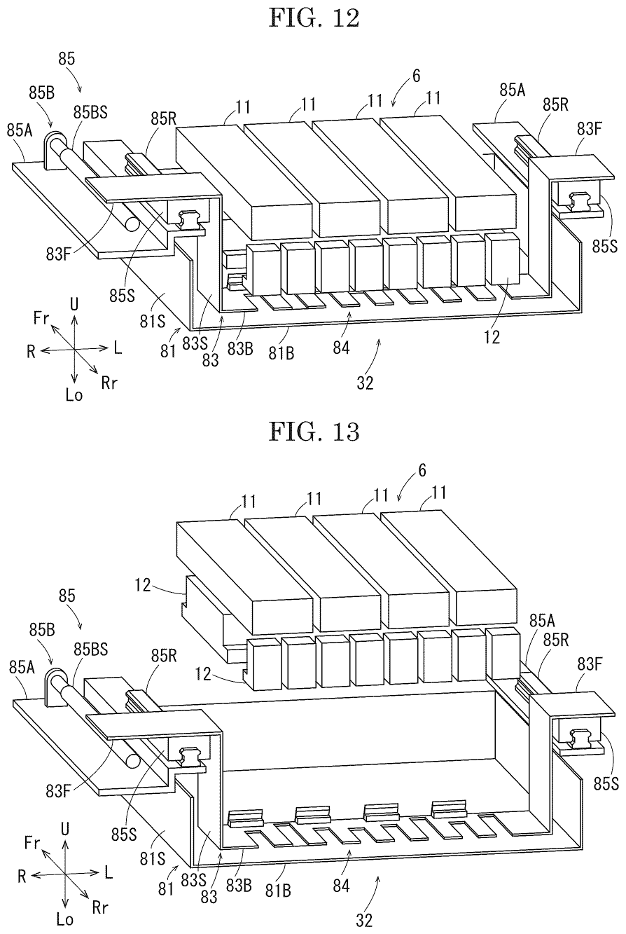

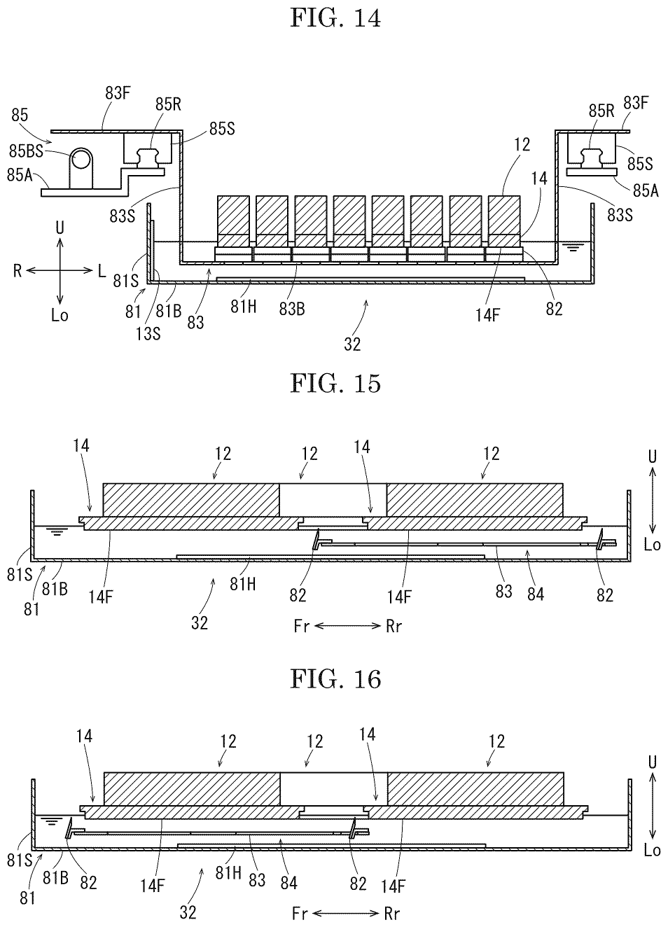

In the facing position, the removing device 32 can be moved upward and downward by using the conveying unit 7. Specifically, the conveying unit 7 can move upward and downward inside the carriage 34 with the removing device 32 placed on the upper portion of the conveying unit 7. The lifting device 35 lifts and lowers the removing device 32 to a separated position where the blade 82 is separated from the nozzle surface 14F (see FIG. 8) and a contact position where the blade 82 comes into contact with the nozzle surface 14F (see FIG. 9).

[Removing Device] FIG. 10 is a perspective view showing the removing device 32. FIG. 11 is a perspective view showing a blade unit 84. FIG. 14 to FIG. 16 are perspective views showing a cross section of the removing device 32. The removing device 32 includes a dipping vessel 81 and a blade unit 84 sliding with respect to the dipping vessel 81.

[Dipping Vessel] The dipping vessel 81 is fixed to the carriage 34 (see FIG. 6). The dipping vessel 81 (see FIG. 10 to FIG. 16) has a rectangular bottom portion 81B when viewed from the upper side, and an upright side wall portion 81S provided around the entire circumference of the front, rear, right and left edges of the bottom portion 81B. In other words, the dipping vessel 81 is opened to the inkjet head 12. The dipping vessel 81 stores a cleaning liquid.

[Blade Unit] The blade unit 84 (see FIG. 11) includes blades 82 and a support plate 83 for supporting the blades 82. The blade 82 is a flexible plate-like member made of rubber or the like. A plurality (in this embodiment, twenty) of the blades 82 are arranged in the same positional relation as the inkjet heads 12. The support plate 83 has a bottom portion 83B, upright side wall portions 83S provided at both right and left ends of the bottom portion 83B, and flange portions 83F protruding leftward and rightward from the left and right side wall portions 83S.

[Driving Device] The removing device 32 is provided with a driving device 85 (see FIG. 5, FIG. 10 and FIG. 14) which slides the blade unit 84 in the front-and-rear direction. The driving device 85 includes support plates 85A, a ball screw 85B, rails 85R, sliding members 85S, and a driving source 85D. The support plates 85A are arranged below the right and left flange portions 83F, and are fixed to the dipping vessel 81 or the carriage 34. The ball screw 85B is provided on one of the right and left support plates 85A. A screw shaft 85BS is attached to the upper surface of the support plate 85A with its axial direction along the front-and-rear direction, and a nut 85BN is attached to the lower surface of the flange portion 83F above the screw shaft 85BS. The driving source 85D includes a motor, a reduction gear, and the others.

The rails 85R are attached to the upper surfaces of the left and right support plates 85A with its longitudinal direction along the front-and-rear direction, and the sliding members 85S are attached to the lower surfaces of the left and right flange portions 83F. The sliding member 85S is fitted to the rail 85R, and is slidable along the rail 85R. When the screw shaft 85BS is driven by the driving source 85D, the blade unit 84 slides in the front-and-rear direction together with the nut 85BN. The driving device 85 is merely an example, and the driving device 85 may be, for example, a belt driving device, a rack and pinion, or the like.

The driving device 85 is provided at a position higher than the maximum height of the liquid level of the liquid which can be stored in the dipping vessel 81. For example, in this embodiment, since the upper edge portion of the side wall portion 81S of the dipping vessel 81 is formed at the same height over the entire circumference, the maximum height of the liquid surface of the liquid that can be stored in the dipping vessel 81 is equal to the height of the upper edge portion of the side wall portion 81S. According to this configuration, a possibility of infiltration of the cleaning liquid into the driving device 85 can be reduced.

In the case of performing wipe processing for removing adhered material from the nozzle surface 14F, the blade unit 84 slides from a slide start position toward a slide end position. In this embodiment, the slide start position is the rear end of the slidable range of the blade unit 84. The slide end position is the front end of the slidable range of the blade unit 84. FIG. 10 to FIG. 13 and FIG. 15 show the blade unit 84 in the slide start position. FIG. 16 shows the blade unit 84 positioned at the slide end position.

Since the blade 82 moves in the cleaning liquid during the wiping processing, splashes of the cleaning liquid may be generated. The driving source 85D is provided closer to the slide start position than the slide end position of the blade 82. According to this configuration, since the blade 82 moves in a direction away from the driving source 85D during the wiping processing, the possibility of infiltration of the cleaning liquid into the driving source 85D can be reduced.

[Cleaning Liquid Supply Device] The inkjet recording apparatus 1 includes a cleaning liquid supply device 13 for supplying the cleaning liquid to the dipping vessel 81 (see FIG. 4). The cleaning liquid supply device 13 includes a cleaning liquid tank 13T for storing the cleaning liquid, and a pump 13P for feeding the cleaning liquid from the cleaning liquid tank 13T. The pump 13P is connected to the dipping vessel 81. To the dipping vessel 81, a suction pump 68 and a waste liquid tank 69 are connected (see FIG. 4).

Thee cleaning liquid supply device 13 supplies the cleaning liquid so that a liquid level is positioned within a predetermined range above the nozzle surface 14F. For example, the dipping vessel 81 is provided with a sensor 13S (see FIG. 14) for detecting a height of a liquid level of the cleaning liquid. The control part 2 drives the pump 13P so that a height of the liquid level detected by the sensor 13S is within the predetermined range above the nozzle surface 14F. According to this configuration, a possibility of infiltration of the cleaning liquid into the driving circuit 12D provided in the inkjet head 12 can be reduced.

Next, an operation of the maintenance device 30 will be described. The following operations are executed by the control part 2 controlling the respective parts of the maintenance device 30.

When the image forming job is executed (see FIG. 6), the removing device 32 is arranged at the lateral retracted position, and the conveying unit 7 is arranged at the image forming position.

The purge processing and the wiping processing are performed at predetermined timing. The predetermined timing is, for example, when a predetermined time has elapsed since the image forming job is completed. In the case of performing the purge processing and the wiping processing, the control part 2 moves the conveying unit 7 to the lower retracted position by the lifting device 35 (see FIG. 7), and moves the carriage 34 to the facing position by the sliding device 36 (see FIG. 8). At this time, the removing device 32 is positioned at the separated position. Next, the control part 2 lifts the conveying unit 7 by the lifting device 35 to lift the removing device 32 to the contact position (see FIG. 9).

The blade unit 84 is positioned at the slide start position (see FIG. 15). At the slide start position, the blade 82 is positioned on the rear side of the nozzle surface 14F.

Subsequently, the control part 2 increases a pressure in the nozzle 14N of the inkjet head 12 to eject the ink (the purge processing). Next, the control part 2 silds the blade unit 84 forward by the driving device 85 (the wiping processing). The blade 82 moves forward while being pressed against the nozzle surface 14F and bent, and scrapes the ink adhering to the nozzle surface 14F. The ink is diluted by the cleaning liquid. The blade unit 84 is stopped at the slide end position (see FIG. 16). At the slide end position, the blade 82 is positioned on the front side of the nozzle surface 14F.

After the wiping processing is completed, the control part 2 waits until the image forming job is input while the removing device 32 is disposed at the contact position. Since the nozzle surface 14F is dipped in the cleaning liquid during this time, an increased in viscosity of the ink in the nozzle 14N is suppressed. The ink is prevented from sticking to the nozzle surface 14F and the blade 82.

When the image forming job is inputted, the control part 2 lowers the removing device 32 to the separated position by the lifting device 35 (see FIG. 8), slides the removing device 32 to the lateral retracted position by the sliding device 36 (see FIG. 7), lifts the conveying unit 7 to the image forming position by the lifting device 35 (see FIG. 6), and then executes the image forming job.

The inkjet recording apparatus 1 according to the embodiment described above includes the inkjet heads 12, the dipping vessel 81 which stores the cleaning liquid, the lifting device 35 which dips the nozzle surface 14F of the inkjet head 12 in the cleaning liquid by lifting or lowering the dipping vessel 81 or the inkjet head 12, and the removing device 32 which is provided in the dipping vessel 81 and removes the adhered material from the nozzle surface 14F. According to this configuration, since the removing device 32 removes the adhered material from the nozzle surface 14F while the nozzle surface 14F is dipped in the cleaning liquid, an ability to remove the adhered material from the nozzle surface 14F can be improved.

Further, the inkjet recording apparatus 1 according to the present embodiment includes the driving device 85 which drives the removing device 32, and the driving device 85 is provided at a position higher than the maximum height of the liquid surface of the liquid that can be stored in the dipping vessel 81. According to this configuration, the possibility of infiltration of the cleaning liquid into the driving device 85 can be reduced.

Further, the inkjet recording apparatus 1 according to the present embodiment includes the the cleaning liquid supply device which supplies cleaning liquid to the dipping vessel 81, and the cleaning liquid supply device 13 supplies the cleaning liquid so that the liquid surface is positioned within the predetermined range above the nozzle surface 14F. According to this configuration, the possibility of infiltration of the cleaning liquid into the driving circuit 12D provided in the inkjet head 12 can be reduced.

Further, according to the inkjet recording apparatus 1 according to the present embodiment, the lifting device 35 maintains a state in which the nozzle surface 14F is dipped in the cleaning liquid during a period in which the image formation by the inkjet head 12 is not performed. With this configuration, it is possible to suppress an increase in viscosity of the ink in the nozzle 14N during a period when the image formation is not performed.

Further, according to the inkjet recording apparatus 1 according to the present embodiment, the lifting device 35 lifts and lowers the dipping vessel 81 or the inkjet head 12 to a position where the nozzle surface 14F is not dipped in the cleaning liquid when the image formation by the inkjet head 12 is performed. With this configuration, it is possible to suppress an increase in viscosity of the ink in the nozzle 14N during a period when the image formation is not performed.

Further, according to the inkjet recording apparatus 1 according to the present embodiment, the removing device 32 is provided with the blade 82 which removes adhered material by sliding in one direction along the nozzle surface 14F, the driving device 85 is provided with the driving source 85D which generates a driving force, and the driving source 85D is provided closer to the slide start position than the slide end position of the blade 82. According to this configuration, the possibility of infiltration of the cleaning liquid into the driving source 85D can be reduced.

The above embodiment may be modified as follows.

In addition to the configuration of the above embodiment, the dipping vessel 81 may include a heater 81H (see FIG. 14) which heats the cleaning liquid. According to this configuration, the ink removing ability can be enhanced by softening the stuck ink and lowering the viscosity of the cleaning liquid.

The above embodiment shows an example in which the removing device 32 is slid into the space formed by lowering the conveying unit 7, but the removing device 32 may be slid into the space formed by lifting the image forming unit 6.

1. An inkjet recording apparatus comprising:
an inkjet head;
a dipping vessel which stores a cleaning liquid;
a lifting device which dips a nozzle surface of the inkjet head in the cleaning liquid by lifting or lowering the dipping vessel or the inkjet head; and
a removing device which is provided in the dipping vessel and removes adhered material from the nozzle surface.

2. The inkjet recording apparatus according to claim 1, comprising:
a driving device which drives the removing device, wherein
the driving device is provided at a position higher than a maximum height of the liquid surface of the liquid that can be stored in the dipping vessel.

3. The inkjet recording apparatus according to claim 1, comprising:
a cleaning liquid supply device which supplies the cleaning liquid to the dipping vessel, wherein
the cleaning liquid supply device supplies the cleaning liquid so that a liquid surface is positioned within a predetermined range above the nozzle surface.

4. The inkjet recording apparatus according to claim 1, wherein
the lifting device maintains a state in which the nozzle surface is dipped in the cleaning liquid during a period in which an image formation by the inkjet head is not performed.

5. The inkjet recording apparatus according to claim 1, wherein
the lifting device lifts and lowers the dipping vessel or the inkjet head to a position where the nozzle surface is not dipped in the cleaning liquid when the image formation by the inkjet head is performed.

6. The inkjet recording apparatus according to claim 2, wherein
the removing device is provided with a blade which removes adhered material by sliding in one direction along the nozzle surface,
the driving device is provided with a driving source which generates a driving force, and
the driving source is provided closer to a slide start position than a slide end position of the blade.

7. The inkjet recoding apparatus according to claim 1, wherein
the dipping vessel is provided with a heater which heats the cleaning liquid.
